(19) United States
(12) Patent Application Publication
(10) Pub. No.: US 2024/0424887 A1
(43) Pub. Date: Dec. 26, 2024

(54) DRIVE UNIT MOUNTING STRUCTURE FOR A VEHICLE

(71) Applicants: HYUNDAI MOTOR COMPANY, Seoul (KR); KIA CORPORATION, Seoul (KR)

(72) Inventors: Won Hae Lee, Seoul (KR); Chang Kyu Kim, Hwaseong-si (KR); Mi Ran Park, Hwaseong-si (KR); Byung Joo Chung, Gunpo-si (KR); Seung Hak Lee, Asan-si (KR); Seon Ki Hwang, Hwaseong-si (KR)

(73) Assignees: HYUNDAI MOTOR COMPANY, Seoul (KR); KIA CORPORATION, Seoul (KR)

(21) Appl. No.: 18/507,795

(22) Filed: Nov. 13, 2023

(30) Foreign Application Priority Data
Jun. 22, 2023 (KR) 10-2023-0080602

(51) Int. Cl. B60K 8/00

(52) U.S. Cl. CPC B60K 8/00

(57) ABSTRACT

A drive unit mounting structure of a vehicle includes a front cross member disposed on a front side of a drive unit and elongated in a transverse direction of the vehicle; a mounting hole formed in the front cross member such that a front end of the drive unit can be inserted therein; and a mounting bush mounted in the mounting hole and installed to support the front end of the drive unit.

### CROSS-REFERENCE TO RELATED APPLICATION(S)

This application claims priority under 35 U.S.C. 119 to Korean Patent Application No. 10-2023-0080602, filed on Jun. 22, 2023, the disclosure of which is herein incorporated by reference in its entirety.

### BACKGROUND

### 1. Field of the Present Disclosure

The present disclosure relates to a technology regarding a structure for mounting a vehicle drive unit.

### 2. Description of the Related Art

A purpose-built vehicle (PBV) refers to a vehicle including a drive module related to vehicle traveling and a life module configured to form various types of boarding and loading spaces according to market demands, the drive module and the life module being separately provided and then coupled to constitute the PBV in line with the market trends towards multi-type small-quantity production.

Therefore, there is an advantage in that a vehicle that satisfies market demands can be quickly produced simply by changing the life module.

Furthermore, in line with recent trends toward eco-friendly vehicle technologies, the drive module has been developed so as to have a power electric (PE) system as a drive unit and to be equipped with a high-voltage battery.

PBV vehicles typically feature a relatively shorter overall vehicle length, an increased wheelbase, and a driving seat positioned to the front as much as possible, in order to improve the utility of passenger spaces and to expand cargo loading spaces while reducing manufacturing costs.

The above-mentioned development trends make it difficult to secure a space in the front of a vehicle to protect against a front-end collision. As a result, the power electric (PE) system provided on the front of a vehicle as a drive unit is likely to be moved backwards by a front-end collision of the vehicle. This increases the risk of injury to passengers and poses a concern of a possible collision with the high-voltage battery mounted behind the PE system.

The above descriptions regarding background technologies of the present disclosure have been made only to help understanding of the background of the present disclosure, and are not to be deemed by those having ordinary skill in the art to correspond to already-known prior arts.

### SUMMARY

The present disclosure provides a drive unit mounting structure for a vehicle (hereinafter “vehicle drive unit mounting structure”). The vehicle drive unit mounting structure efficiently suppresses and prevents a backward movement of a drive unit mounted on the front of a vehicle when a front-end collision accident of the vehicle occurs such that the vehicle safety is improved, reducing passenger injuries and minimizing damage to a high-voltage battery of the vehicle.

In an aspect of the present disclosure, the vehicle drive unit mounting structure may include: a front cross member disposed on a front side of a drive unit and elongated in a transverse direction of a vehicle; a mounting hole formed in the front cross member such that a front end of the drive unit can be inserted therein; and a mounting bush mounted in the mounting hole and installed to support the front end of the drive unit.

Both ends of the front cross member may be fixed to side members disposed on both sides of the vehicle and elongated in a forward/backward direction of the vehicle.

The drive unit may have a mounting block configured to form the front end, and the mounting block may be shaped to have a section expanded from the front end toward a rear side.

The mounting block may be formed to have a section that expands from the front end toward the rear side, exceeding the size of the mounting hole.

Multiple local reduced-strength portions may be provided around the mounting hole of the front cross member to induce deformation.

The reduced-strength portions of the front cross member may be configured as openings, at least a part of which is open toward the drive unit.

Multiple mounting pipes may be provided around the mounting hole of the front cross member and elongated in the forward/backward direction of the front cross member so as to mount the mounting bush.

The mounting bush may be inserted so as to penetrate the front cross member in the forward/backward direction, and may be fixed to the front cross member by multiple mounting bolts fastened to the multiple mounting pipes.

An alignment protrusion may be integrally formed on the front end of the mounting block so as to protrude forwards such that, when the drive unit is moved downwards for alignment with the mounting bush, the alignment protrusion engages with an upper surface of the mounting bush.

The front end of the mounting block of the drive unit may be coupled to the mounting bush by a fastening bolt fastened through the mounting bush mounted on the front cross member.

In another aspect of the present disclosure, a vehicle drive unit mounting structure of a vehicle may include: a mounting block mounted on a front side of a drive unit; a front cross member provided on the front side of the drive unit in a transverse direction of the vehicle; a mounting bush coupled to a front side of the mounting block such that the drive unit is fixed to the front cross member in a vibration-insulated state; and a shock-absorbing unit configured to be able to absorb a shock resulting from a collision between the front cross member and the mounting block.

The shock-absorbing unit may include a mounting hole formed in the front cross member so as to provide a space to mount the mounting bush and during a collision accident, the mounting block is inserted into the mounting hole and gradually deformed to absorb shocks.

The shock-absorbing unit may include multiple reduced-strength portions formed locally around the mounting hole to induce deformation.

The reduced-strength portions may be configured as openings, at least a part of which is open toward the drive unit.

The shock-absorbing unit may include a changed-section portion of the mounting block configured to have a section smaller than the diameter of the mounting hole at the front end thereof so as to be inserted into the mounting hole. The section gradually expands backwards, exceeding the diameter of the mounting hole.

An alignment protrusion may be provided on the front end of the mounting block so as to protrude toward the mounting bush, thereby guiding a state of alignment with the mounting bush.

The alignment protrusion may be formed to protrude in an arc shape so as to surround the rear upper side of the mounting bush.

The mounting block may be coupled to the mounting bush by a fastening bolt fastened through the mounting bush from the front side of the vehicle.

A mounting flange may be provided on the front side of the mounting bush, and the front cross member has multiple mounting pipes elongated in the forward/backward direction of the vehicle such that mounting bolts are fastened thereto through the mounting flange.

The present disclosure is advantageous in that a backward movement of a drive unit mounted on the front of a vehicle caused by a front-end collision of the vehicle is effectively suppressed or prevented, which would otherwise injure passengers with an increased possibility and damage a high-voltage battery, thereby further improving the vehicle safety.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 illustrates a vehicle drive unit mounting structure according to an embodiment of the present disclosure;

FIG. 2 is a detailed view of an area in which a drive unit and a front cross member in FIG. 1 are coupled;

FIG. 3 is a view seen in direction III in FIG. 1;

FIG. 4 is a view seen in direction IV in FIG. 2;

FIG. 5 is a perspective view of the drive unit in FIG. 1;

FIG. 6 is a lateral view of the drive unit in FIG. 5;

FIG. 7 is a bottom view of the drive unit in FIG. 5; and

FIG. 8 is a sectional view taken along line VIII-VIII in FIG. 2.

### DETAILED DESCRIPTION OF THE EXEMPLARY EMBODIMENTS

Hereinafter, embodiments disclosed in the present specification are described in detail with reference to the accompanying drawings, and the same or similar elements are given the same and similar reference numerals, so duplicate descriptions thereof have been omitted.

The terms “module” and “unit” used for the elements in the following description are given or interchangeably used in consideration of only the ease of writing the specification, and do not have distinct meanings or roles by themselves.

In describing the embodiments disclosed in the present specification, when the detailed description of the relevant known technology is determined to unnecessarily obscure the gist of the present disclosure, the detailed description is omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element. When a component, device, element, or the like of the present disclosure is described as having a purpose or performing an operation, function, or the like, the component, device, or element should be considered herein as being “configured to” meet that purpose or to perform that operation or function.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

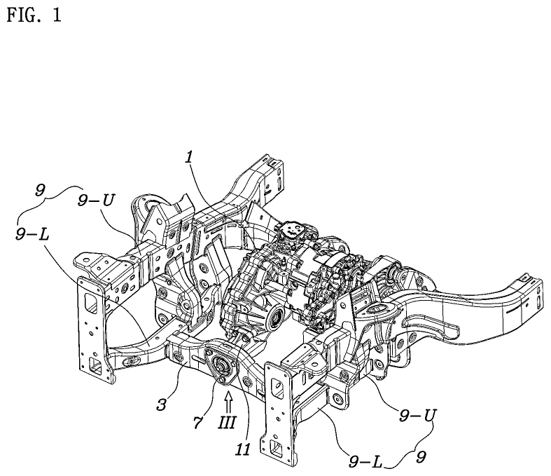

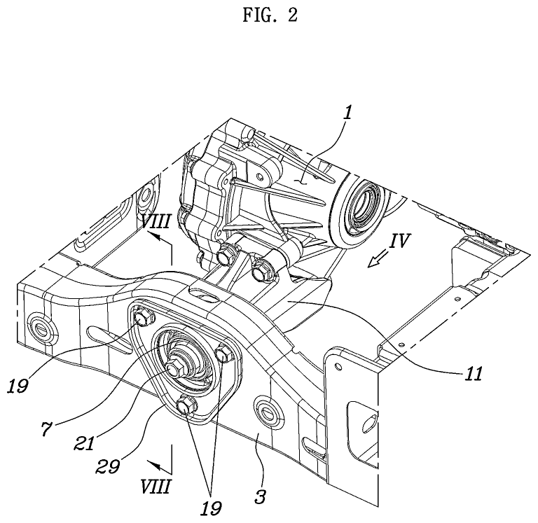

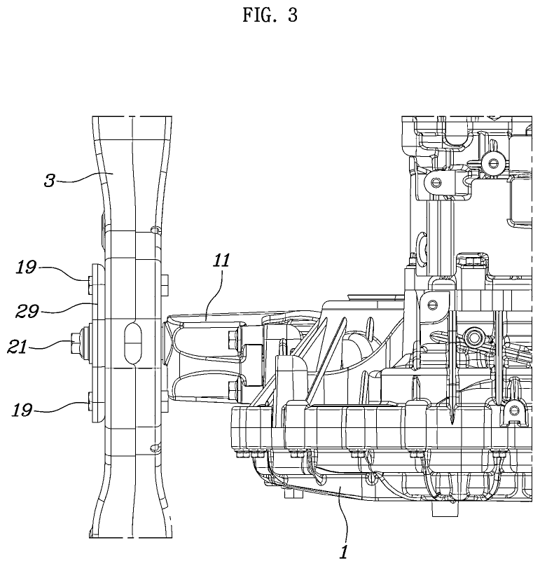

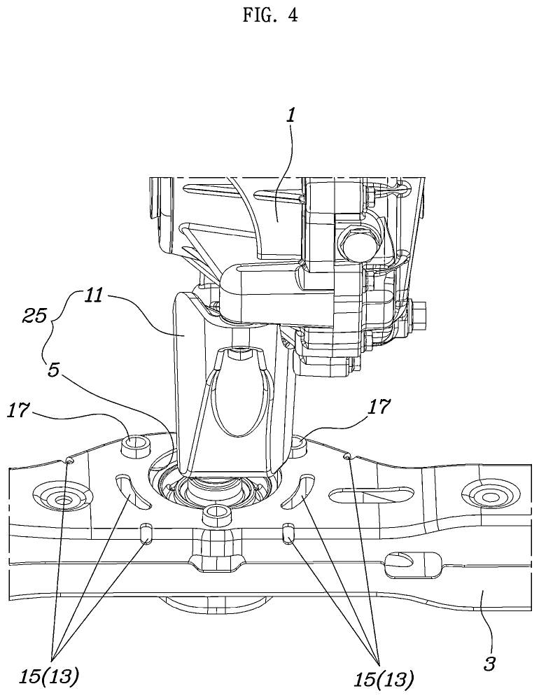

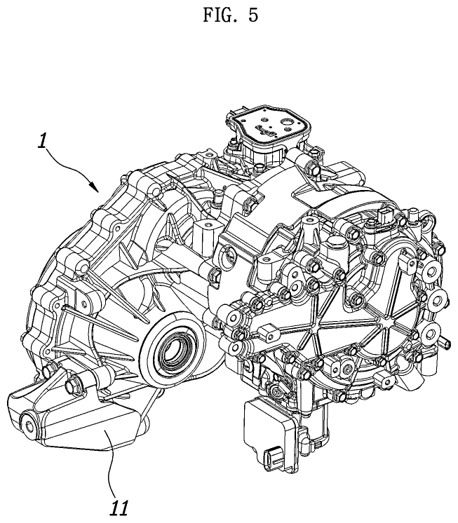

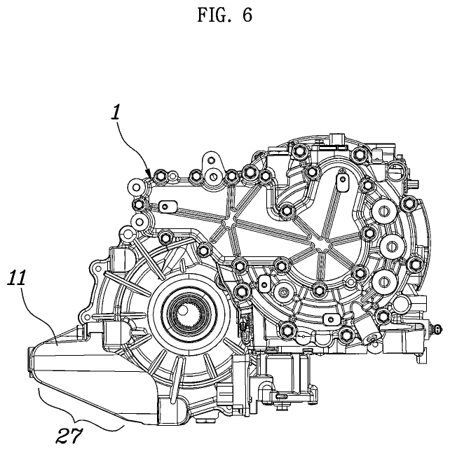

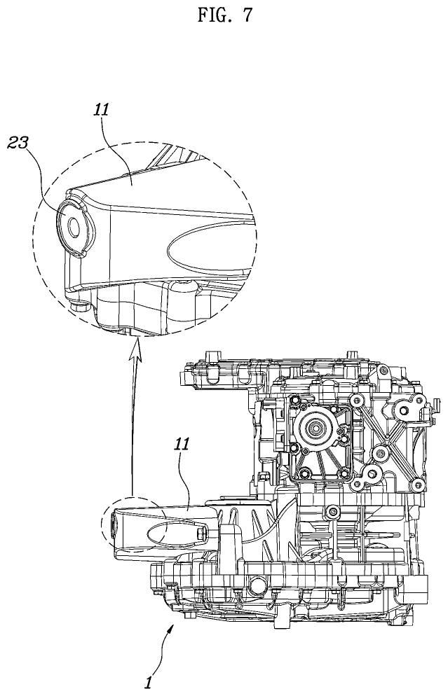

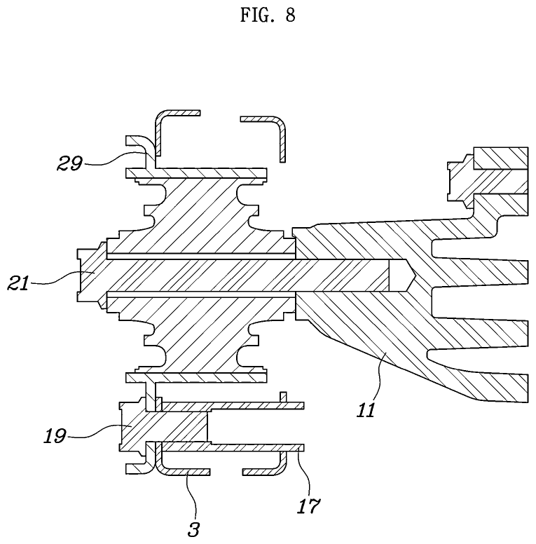

Referring to FIG. 1 to FIG. 8, a vehicle drive unit mounting structure according an embodiment of the present disclosure includes a front cross member 3 disposed on the front of a drive unit 1 and elongated in the transverse direction of the vehicle; a mounting hole 5 formed in the front cross member 3 such that the front end of the drive unit 1 can be inserted therein; and a mounting bush 7 mounted in the mounting hole 5 and installed to support the front end of the drive unit 1.

In other words, the front of the vehicle drive unit 1 is mounted on the front cross member 3 positioned on the front of the vehicle through the mounting bush 7.

For reference, the drive unit 1 may be a power electric (PE) system incorporating a drive motor or the like, or may include a conventional internal combustion engine, a transmission, and the like.

Both ends of the front cross member 3 are fixed to side members 9 disposed on both sides of the vehicle and elongated in the forward/backward direction.

For reference, in the embodiment in FIG. 1, the side members 9 include upper side members 9-U and lower side members 9-L, and both ends of the front cross member 3 are coupled to the lower side members 9-L.

In addition, the front side of the drive unit 1 is coupled to the front cross member 3 through the mounting bush 7 as described above, and the rear side or another part of the drive unit 1 may be fixed to a frame, chassis, or the like through a mounting mechanism.

The drive unit 1 has a mounting block 11 configured to form the front end, and the mounting block 11 is shaped to have a section expanded from the front end toward the rear.

Particularly, the mounting block 11 is formed to have a section expanded from the front end toward the rear, exceeding the size of the mounting hole 5.

Accordingly, if the front cross member 3 is moved backwards by a shock applied to the rear side of the vehicle during a front-end collision of the vehicle, for example, the drive unit 1 which is regarded as a rigid body having a very large inertia collides with the front cross member 3. The front end of the mounting block 11 of the drive unit 1 is first inserted into the mounting hole 5 of the front cross member 3. The mounting block 11 then deforms the mounting hole 5, thereby absorbing the shock energy caused by the collision.

Therefore, during a front-end collision of the vehicle, the front cross member 3 can be prevented from pressurizing the drive unit 1 backwards without being buffered (or such pressurization can be reduced). The drive unit 1 would otherwise deform the dashboard behind the same, for example, and penetrate the passenger room, thereby injuring passengers or damaging a high-voltage battery.

Multiple local reduced-strength portions 13 may be provided around the mounting hole 5 of the front cross member 3 so as to induce deformation.

In one embodiment, each reduced-strength portion 13 of the front cross member 3 may be an incision hole 15, at least a part of which is open toward the drive unit 1, for example.

Obviously, the reduced-strength portions 13 are not necessarily configured as openings 15 as described above, and may also be configured as grooves with locally reduced thickness.

Therefore, if the front cross member 3 is moved backwards by a front-end collision of the vehicle as described above, the mounting block 11 further facilitates deformation of the mounting hole 5 and peripheral portions thereof such that the energy of the front cross member 3 which pressurizes the drive unit 1 backwards is reduced more easily, thereby substantially lowering the possibility that the backward movement of the drive unit 1 will injure passengers or damage the high-voltage battery.

Multiple mounting pipes 17 are provided around the mounting hole 5 of the front cross member 3 and elongated in the forward/backward direction of the front cross member 3 in order to mount the mounting bush 7.

The mounting bush 7 is inserted so as to penetrate the front cross member 3 in the forward/backward direction, and is fixed to the front cross member 3 by multiple mounting bolts 19 fastened to the multiple mounting pipes 17.

In addition, the front end of the mounting block 11 of the drive unit 1 is coupled to the mounting bush 7 by fastening bolts 21 fastened through the mounting bush 7 mounted on the front cross member 3.

Therefore, the drive unit 1 remains supported on the front cross member 3 such that the mounting bush 7 insulates vibrations thereof, thereby enabling vehicle occupants to feel comfortable and relaxed, and is not excessively moved backwards even if the front cross member 3 is moved backwards by a collision accident as described above, thereby preventing passenger injury or high-voltage battery damage.

An alignment protrusion 23 is integrally formed on the front end of the mounting block 11 so as to protrude forwards such that, when the drive unit 1 is moved downwards for alignment with the mounting bush 7, the alignment protrusion 23 engages with the upper surface of the mounting bush 7.

Therefore, when the drive unit 1 is assembled to the mounting bush 7, the fastening bolts 21 are coupled while the mounting bush 7 and the mounting block 11 are aligned more easily by the alignment protrusion 23, thereby ensuring that the drive unit 1 is mounted easily.

In another embodiment of the present disclosure, a vehicle drive unit mounting structure for a vehicle may include: a mounting block 11 mounted on the front side of a drive unit 1; a front cross member 3 provided on the front side of the drive unit 1 in the transverse direction of the vehicle; and a mounting bush 7 coupled to the front side of the mounting block 11 such that the drive unit 1 is fixed to the front cross member 3 in a vibration-insulated state. The vehicle drive unit mounting structure further includes a shock-absorbing unit 25 configured to absorb shock when a collision between the front cross member 3 and the mounting block 11 occurs.

In one embodiment, the shock-absorbing unit 25 includes a mounting hole 5 formed in the front cross member 3 so as to provide a space to mount the mounting bush 7 and to ensure that, in the case of a collision accident, the mounting block 11 is inserted therein and is gradually deformed, thereby absorbing shock.

In addition, the shock-absorbing unit 25 may include multiple reduced-strength portions 13 formed locally around the mounting hole 5 so as to induce deformation.

In the present embodiment, each reduced-strength portion 13 is an incision hole 15, at least a part of which is open toward the drive unit 1.

In addition, the shock-absorbing unit 25 includes a changed-section portion 27 of the mounting block 11 configured to have a section smaller than the diameter of the mounting hole 5 at the front end thereof so as to be inserted into the mounting hole 5, the section being gradually expanded backwards beyond the diameter of the mounting hole 5.

An alignment protrusion 23 may be provided on the front end of the mounting block 11 so as to protrude toward the mounting bush 7, thereby guiding alignment with the mounting bush 7.

In the present embodiment, the alignment protrusion 23 is formed to protrude in an arc shape so as to surround the rear upper side of the mounting bush 7.

The mounting block 11 is coupled to the mounting bush 7 by fastening bolts 21 fastened through the mounting bush 7 from the front of the vehicle.

A mounting flange 29 is provided on the front side of the mounting bush 7. The front cross member 3 has multiple mounting pipes 17 elongated in the forward/backward direction of the vehicle such that mounting bolts 19 are fastened thereto through the mounting flange 29.

Although the present disclosure has been described and illustrated in conjunction with particular embodiments thereof, it should be apparent to those having ordinary skill in the art that various improvements and modifications may be made to the present disclosure without departing from the technical idea of the present disclosure.

What is claimed is:

1. A drive unit mounting structure of a vehicle, comprising:
a front cross member disposed on a front side of a drive unit and elongated in a transverse direction of the vehicle;
a mounting hole formed in the front cross member such that a front end of the drive unit is configured to insert into the mounting hole; and
a mounting bush mounted in the mounting hole and configured to support the front end of the drive unit.

2. The drive unit mounting structure of claim 1, wherein both ends of the front cross member are fixed to side members disposed on both sides of the vehicle and elongated in a forward/backward direction of the vehicle.

3. The drive unit mounting structure of claim 1, wherein the drive unit has a mounting block configured to form the front end, and the mounting block is shaped to have a section expanded from the front end toward a rear side.

4. The drive unit mounting structure of claim 3, wherein the mounting block is formed to have a section expanded from the front end toward the rear side and having a size greater than a size of the mounting hole.

5. The drive unit mounting structure of claim 4, wherein multiple local reduced-strength portions are provided around the mounting hole of the front cross member to induce deformation.

6. The drive unit mounting structure of claim 5, wherein the multiple local reduced-strength portions of the front cross member are configured as openings, at least a part of which is open toward the drive unit.

7. The drive unit mounting structure of claim 4, wherein multiple mounting pipes are provided around the mounting hole of the front cross member and elongated in a forward/backward direction of the vehicle so as to mount the mounting bush.

8. The drive unit mounting structure of claim 7, wherein the mounting bush is inserted so as to penetrate the front cross member in the forward/backward direction, and is fixed to the front cross member by multiple mounting bolts fastened to the multiple mounting pipes.

9. The drive unit mounting structure of claim 3, wherein an alignment protrusion is integrally formed on the front end of the mounting block so as to protrude forwards such that, when the drive unit is moved downwards for alignment with the mounting bush, the alignment protrusion engages with an upper surface of the mounting bush.

10. The drive unit mounting structure of claim 3, wherein the front end of the mounting block of the drive unit is coupled to the mounting bush by a fastening bolt fastened through the mounting bush mounted on the front cross member.

11. A drive unit mounting structure for a vehicle, comprising:
a mounting block mounted on a front side of a drive unit;
a front cross member provided on the front side of the drive unit in a transverse direction of the vehicle;
a mounting bush coupled to a front side of the mounting block such that the drive unit is fixed to the front cross member in a vibration-insulated state; and
a shock-absorbing unit configured to absorb a shock resulting from a collision between the front cross member and the mounting block.

12. The drive unit mounting structure of claim 11, wherein the shock-absorbing unit comprises a mounting hole formed in the front cross member so as to provide a space to mount the mounting bush, and during a collision accident, the mounting block is inserted into the mounting hole and gradually deformed to absorb shocks.

13. The drive unit mounting structure of claim 12, wherein the shock-absorbing unit comprises multiple reduced-strength portions formed locally around the mounting hole to induce deformation.

14. The drive unit mounting structure of claim 13, wherein the reduced-strength portions are configured as openings, at least a part of which is open toward the drive unit.

15. The drive unit mounting structure of claim 12, wherein the shock-absorbing unit comprises a changed-section portion of the mounting block configured to have a section smaller than a diameter of the mounting hole at a front end thereof so as to be inserted into the mounting hole, and wherein the changed-section portion is configured to gradually expand backwards and have a size greater than the diameter of the mounting hole.

16. The drive unit mounting structure of claim 15, wherein an alignment protrusion is provided on the front end of the mounting block so as to protrude toward the mounting bush, thereby guiding a state of alignment with the mounting bush.

17. The drive unit mounting structure of claim 16, wherein the alignment protrusion is formed to protrude in an arc shape so as to surround a rear upper side of the mounting bush.

18. The drive unit mounting structure of claim 15, wherein the mounting block is coupled to the mounting bush by a fastening bolt fastened through the mounting bush from the front side of the vehicle.

19. The drive unit mounting structure of claim 12, wherein a mounting flange is provided on the front side of the mounting bush, and the front cross member has multiple mounting pipes elongated in a forward/backward direction of the vehicle such that mounting bolts are fastened thereto through the mounting flange.
